(19) United States
(12) Patent Application Publication
(10) Pub. No.: US 2015/0068121 A1
(43) Pub. Date: Mar. 12, 2015

(54) TIERED HYDROPONIC GROWING STAND

(71) Applicant: Mobile Farming Systems, Inc., Azusa, CA (US)

(72) Inventors: Richard J. Probst, Azusa, CA (US); Tino M. Vargas, Murrieta, CA (US); Richard F. O'Connor, Rancho Mirage, CA (US)

(21) Appl. No.: 14/021,741

(22) Filed: Sep. 9, 2013

(51) Int. Cl. A01G 31/06; A47F 7/00

(52) U.S. Cl. CPC A01G 31/06; A47F 7/00
USPC 47/59 R; 211/85.23

(57) ABSTRACT

A stand for hydroponic growing has multiple tiered horizontal shelves supported by curved arms with the arms attached to a base that includes a tank with a pump. The shelves are hollow, shallow troughs with a cover. The covers have openings to accommodate planting baskets and liquid nutrients are pumped from the tank to and through the shelves. In some versions the shelves are tilted to reduce the incident of a growing plant interfering with or being interfered with by the shelf above it. Also it causes the plants to hang down in a predetermined direction making it easier to provide a trellis or other plant matter directional control. In some versions the growing baskets have a tab that interacts with a slot in the shelf cover to help secure the growing basket to the shelf.

### RELATED APPLICATIONS

This application claims priority to and hereby includes by reference in its entirety US 29/446012 filed on Feb. 19, 2013.

### FIELD

This is directed to an apparatus for holding plants on horizontal shelves and delivering nutrients to be used in soil-free horticulture.

### BACKGROUND

Hydroponic systems have been known for many years and after a slow start they have found application in some horticultural niches. One application where hydroponics has not been very successful to date is with the home gardener. Hydroponics have been seen as suitable for medium scale commercial growing and the available equipment has not been viewed by most home gardeners as simple enough, compact enough and attractive enough for their use.

### SUMMARY

A tiered shelving system can have enclosed shelves that act as troughs with openings in the enclosure to accommodate planting baskets. Arms that extend upward and rearward from a tank can support the shelves. With liquid in the tank, it can act as a counter-weighted base to provide stability to the tiered shelves and the plants they support. The shelves can be attached to the arms in a manner that makes them readily removable for cleaning. And the arms, shelves, and openings for planting baskets can be configured to support plants at an orientation that is tilted from normal to the ground.

### BRIEF DESCRIPTION OF THE DRAWINGS

FIG. 1 is a perspective view of a three-shelf version of a hydroponic planting stand with baskets inserted;

FIG. 2A is a side view of the unit of FIG. 1;

FIG. 2B is the same view as 2A with the addition of plants;

FIG. 2C shows an enlarged, fragmentary view of a section of FIG. 2A where a tube is retained in an arm;

FIG. 3 is a front view of the unit of FIG. 1;

FIG. 4 is a plan view of the unit of FIG. 1;

FIG. 5 is a schematic view showing the liquid flow;

FIG. 6 shows a partially exploded, perspective view of the unit of FIG. 1 with the top shelf removed from the arms of the stand and the upper portion of the shelf removed from the base of the shelf;

FIG. 7 shows an isolated shelf with grow baskets exploded from the shelf;

FIG. 8 is an enlarged perspective view of the underside of a basket;

FIG. 9A is a fragmentary, enlarged, cut away view of a basket being inserted in an opening;

FIG. 9B is the view of FIG. 9A with the basket being locked into place;

FIG. 10 shows a side view of a second embodiment.

### DETAILED DESCRIPTION

### First Embodiment

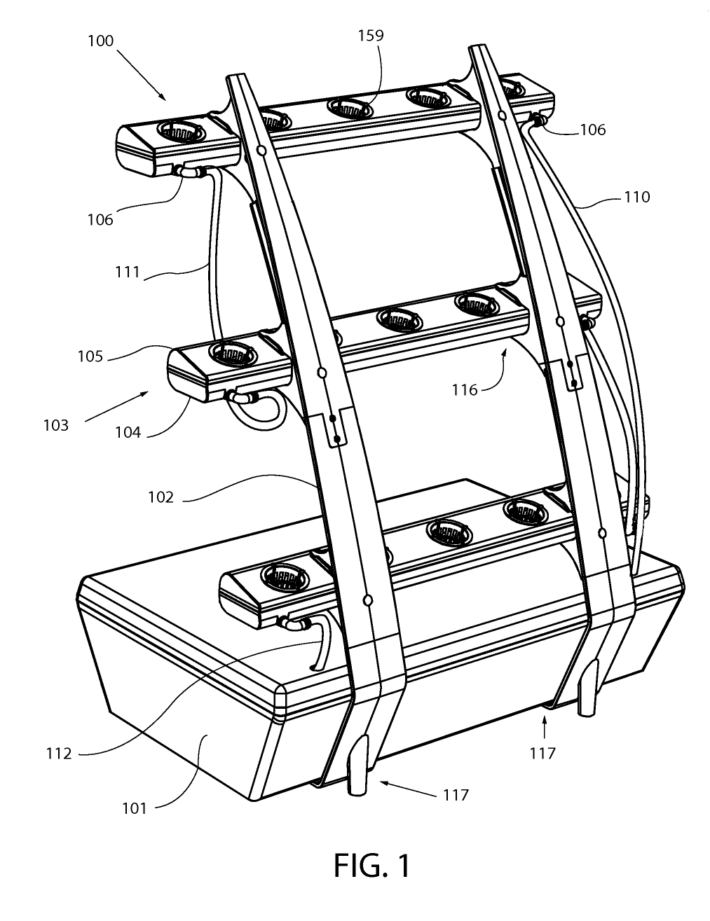

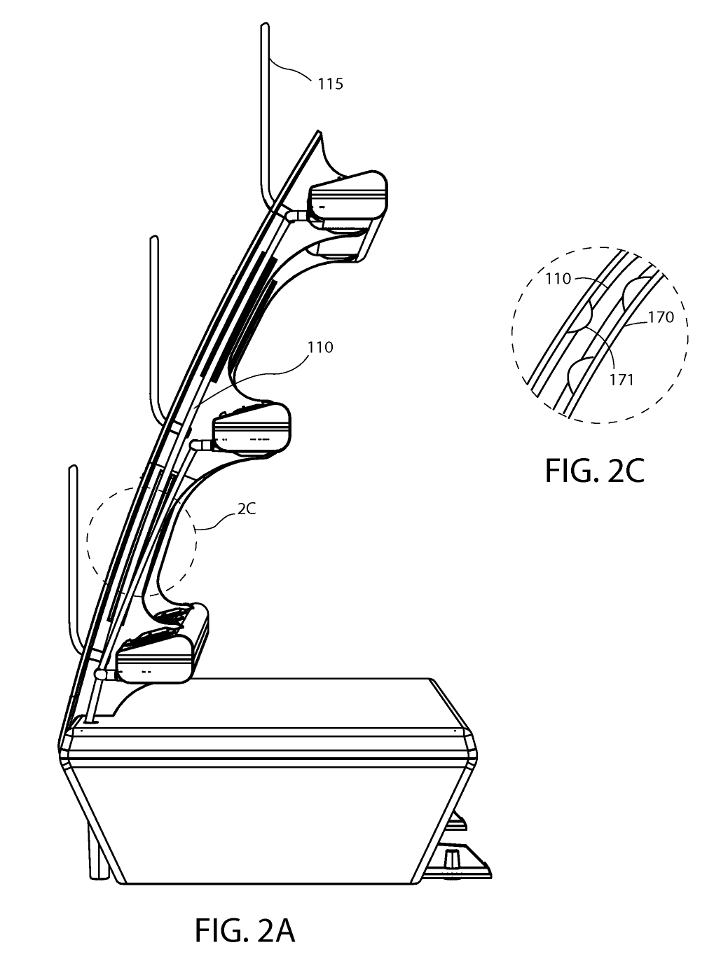

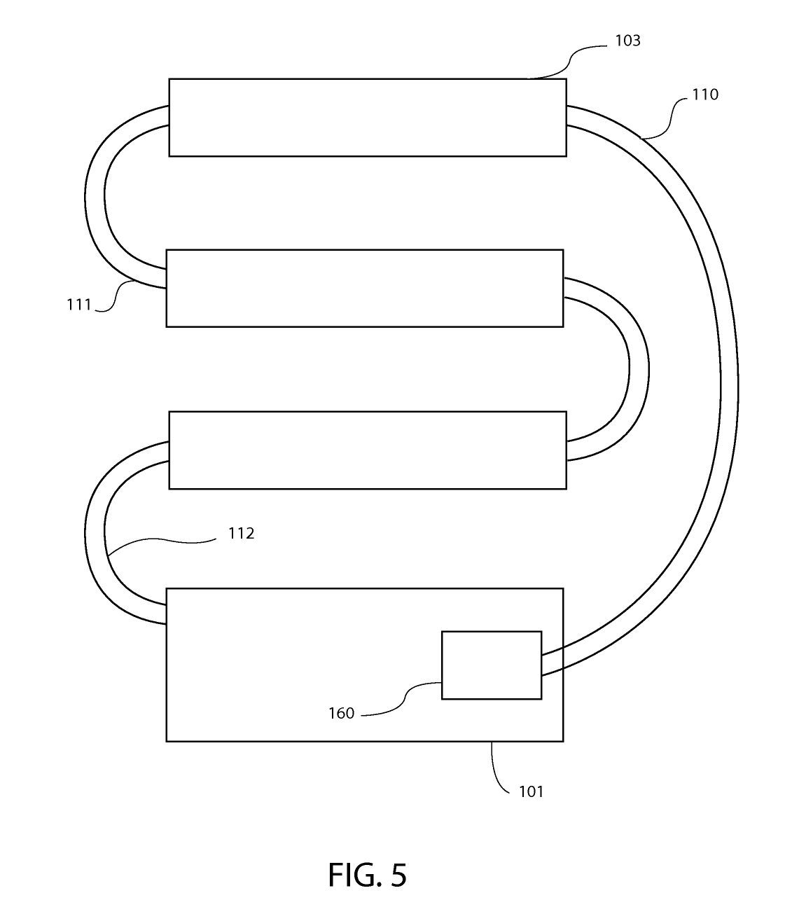

The first embodiment 100 is seen in FIG. 1. It is a tiered shelving system with the shelves 103 supported by arcuate arms 102 that extend from a tank 101 that acts as a base for the apparatus. The weight of the tank, when filled, acts as an effective counter-weight to the mass of the growing vegetation. The shelves 103 are shallow, enclosed troughs. This allows them to hold the liquid with nutrients that are needed for hydroponic growing in a lower portion 104. With an open-able or removable cover 105, the entire interior surfaces of the troughs are readily cleanable. This is further facilitated by ready detachability of the shelves from the arms. Better seen in FIG. 2A and FIG. 6, the arms are notched 116 on their rear-facing sides and the profile of the shelves allows them to be inserted into the notches and be retained by gravity in a cantilevered position. Other versions might have a friction fit, a snap fit or a simple latch. This FIG. 2A also shows the angle at which the basket is held. In FIG. 2B the reason for the tilted plant orientation is seen. The plants' 118 vegetation tends to lean towards the front of the unit making for a neater appearance, ease of tending and the ability to direct the growth via a trestle or net (not shown) that might be supported by the upright posts 115. Note that these posts may be optional and are shown in some but not all of the figures.

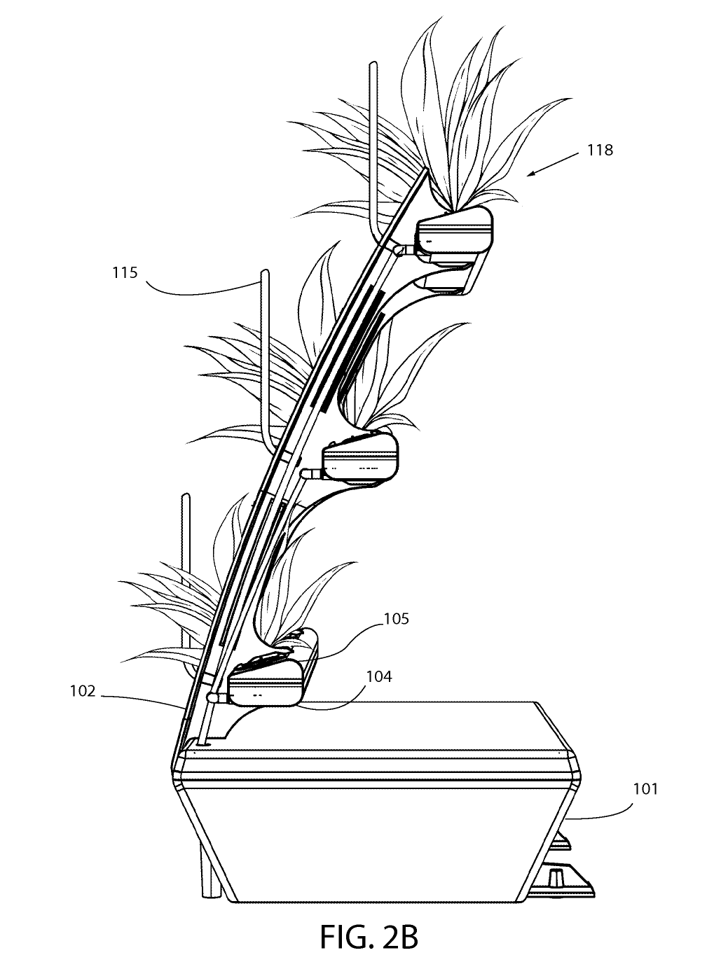

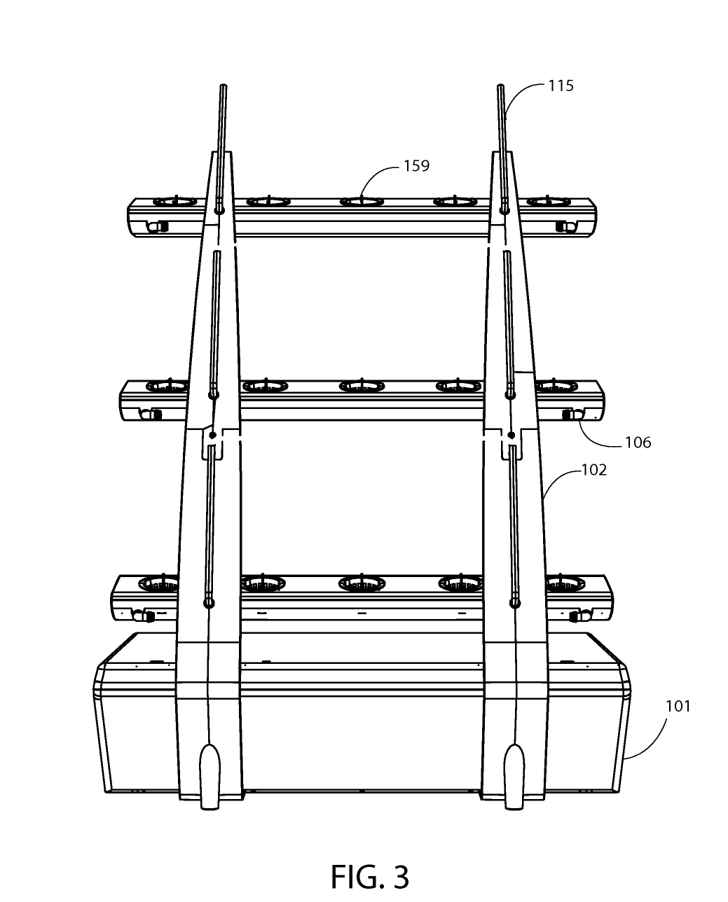

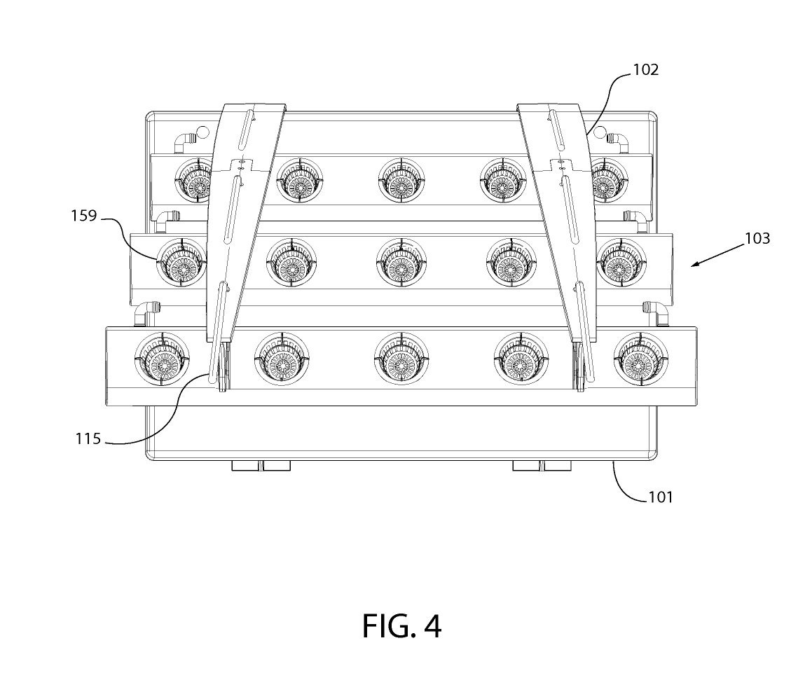

FIGS. 3 and 4 show the unit from a front and plan view respectively to aid in the understanding of the structure of this embodiment. In FIG. 5 a representation of the flow of liquid nutrients is shown. A pump 160 located in the tank of the base 101 feeds liquid up the feed tube 110 to the uppermost shelf. As that shelf fills, liquid is emitted from the other end of the shelf to a short daisy-chain tube 111. From there gravity carries the liquid in the same manner to the lower shelves. At the lowermost shelf the return tube 112 carries the liquid back to the tank.

As mentioned above, and well diagramed in FIG. 6, the shelves 103 fit into large notches 116 in the arms 102. The profile of the shelf as a whole is the same as the notch and the shelves are well supported in a cantilevered manner. This attachment could be made in other ways including a snap fit, a latch, etc. Also seen in this figure is the separation of the shelf cover 105 from the shelf lower portion 104. In this embodiment it is a snuggly fitting cover but it could also be hinged. The open-ability of the shelf, and removability of the shelf allows for ready and complete cleaning of its interior and exterior.

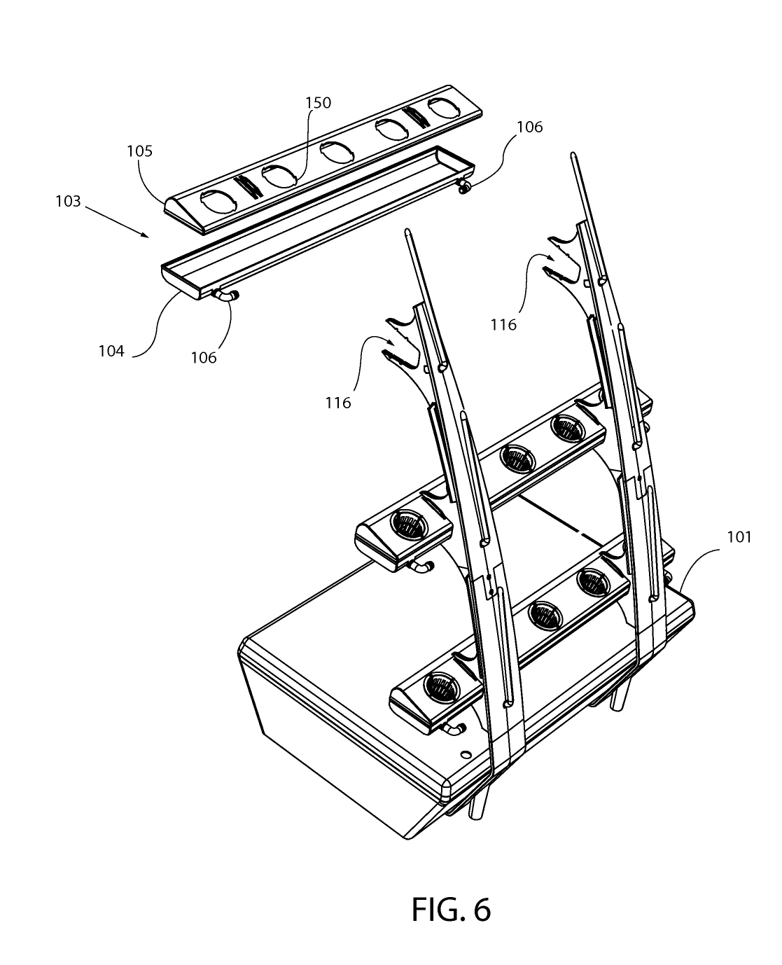

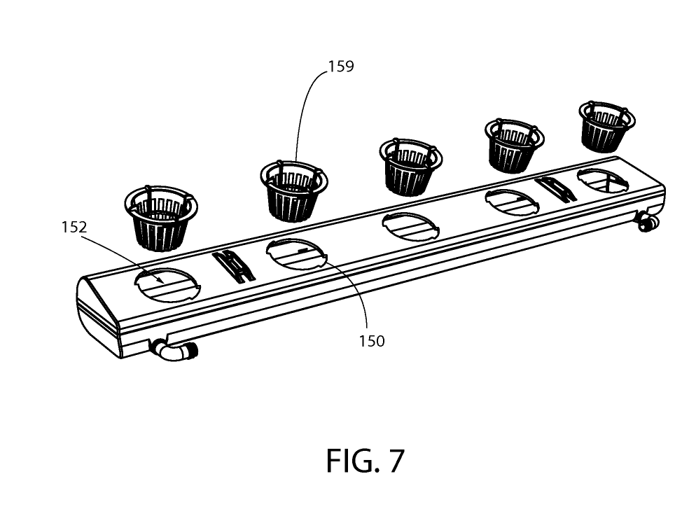

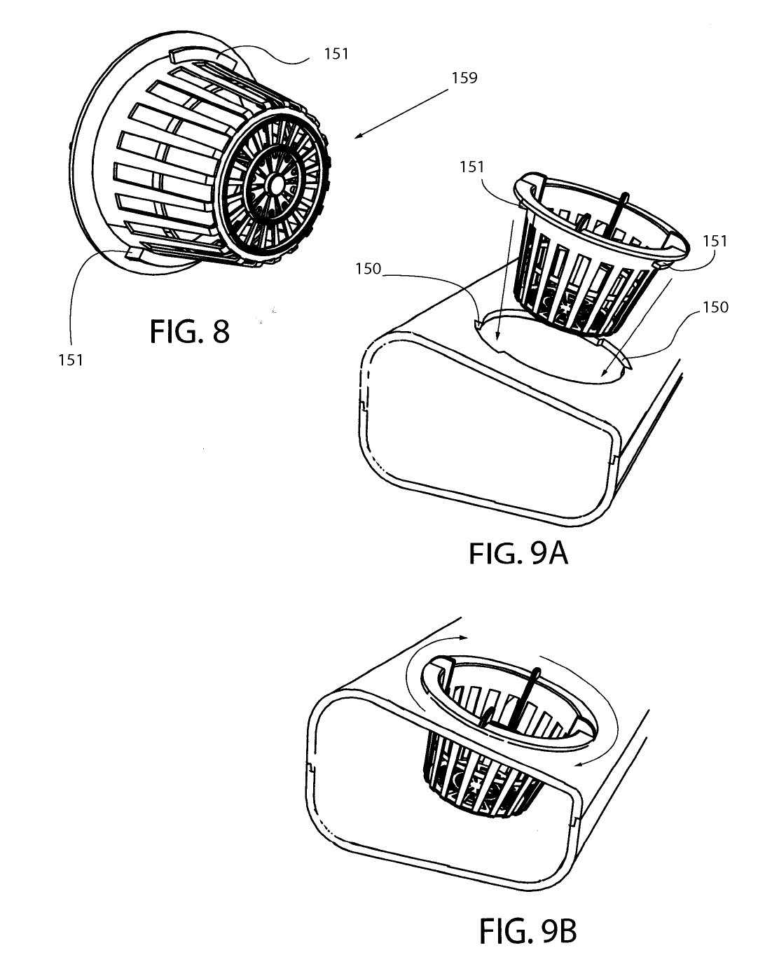

As seen in FIG. 7 the openings 152 in the cover are circular with two wide shallow slots 150 along the perimeter. These slots are aligned with the tabs 151 on the growing basket seen in FIG. 8. When inserted in the shelf as seen in FIG. 9A, the tabs and slots are aligned. The basket is turned as seen in FIG. 9B and the tabs help to retain the basket even though they are slightly tilted.

### Variations

Many variations of the first embodiment are possible. In some versions the shelves snap into notches in the arms for ready assembly and disassembly. In some versions the arms contain clips or tabs to hold the various tubes up against or within the arms providing a neater and more attractive appearance. FIG. 2C shows a fragmentary, enlarged view of one way to accomplish this but many other ways are known. It is also possible for one or more portions of the flexible tube lengths to be replaced by rigid pipes imbedded in or integral to the arms.

Although arcuate in the version shown, the arms could be leaned back at about the same angle but be straight. Baskets could be square and could be retained by a latch or other well-known mechanism. The posts for trestle or net support could be absent. The stand may also include a trellis, different trellis supports, netting supports and other accessories for growing and tending to the plants.

### Second Embodiment

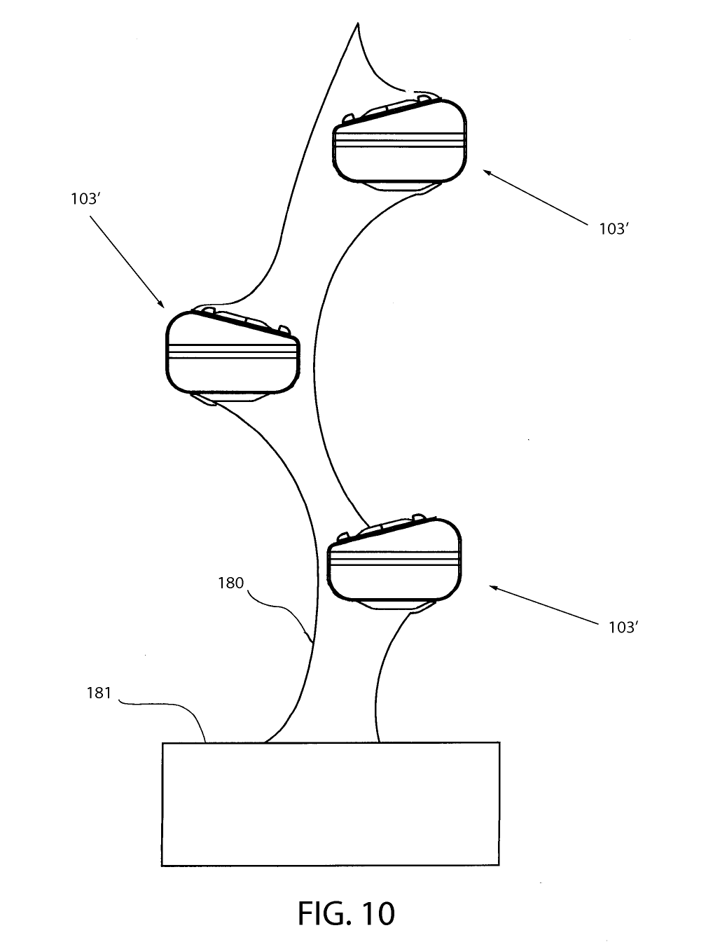

In an alternative embodiment the arms can be attached more centrally to the base and extend straight up or almost straight up. The arms can be a continuous S-shaped curve as seen in the side view of FIG. 10. Shelves are attached at portions of the curve so that sequential shelves are not directly above each other but staggered. In the version shown in FIG. 10 the shelves are similar to the shelves of the first embodiment. The shelves can be all tilted in alternating directions as shown or, if the attachment point is moved off-center of the tank, they could all tilt in the same direction.

It is claimed:

1. A hydroponic growing stand comprising:
a) a base having a front, a back, and left and right sides;
b) two arms extending in parallel upward and rearward from positions at the front of the base, respectively on opposing sides of the base; and
c) at least two shelves, at least some of the shelves readily attachable and removable at respective positions along the arms, and when so attached being supported horizontally by the arms; at least one of the shelves comprising a shallow enclosed trough having openings in an upper surface of a size and shape to accommodate a plant growing basket.

2. The growing stand of claim 1 where the orientation of at least one shelf when supported horizontally by the arms is tilted towards the front of the base by between about 10-degrees and 20-degrees.

3. The growing stand of claim 1 where at least one of the shelves comprises a lower trough portion and an upper cover portion with the cover portion readily open-able to provide full access to the interior of the at least one shelf for cleaning.

4. The growing stand of claim 1 further comprising a pump.

5. The growing stand of claim 1 in a disassembled form.

6. The growing stand of claim 1 where the attachability and removability of at least one shelf being inherent in the shape of the arms and shelves and not requiring added hardware.

7. The growing stand of claim 3 where at least one of the shelves further comprises liquid communication fittings proximate to either end.

8. The growing stand of claim 7 further comprising a pump.

9. The growing stand of claim 8 where at least one shelf is at an elevation higher than at least one other shelf, and further comprising tubing from the pump to the fitting at one end of the higher shelf and from the fitting at opposing end of the higher shelf to a fitting proximal to an end of a lower shelf.

10. A shelf for hydroponic growing that is an enclosed, shallow trough with a generally planar cover portion where the cover portion has at least one generally circular opening configured to accommodate a frustoconical growing basket, the circular opening having at least one region constituting a slot configured to receive a corresponding tab on a growing basket.

11. The shelf of claim 10 further comprising liquid communication fittings proximate to either end.

12. A method of hydroponic growing comprising:
a) pumping a liquid from a tank to a first horizontally disposed shelf where the shelf is a shallow, covered trough holding plant baskets and the shelf is held above the level of the tank by a pair of elongated arms with notches that the shelf fits into and is held in place in a cantilevered manner without a requirement for fasteners;
b) passing the liquid through the first shelf;
c) flowing the liquid, by gravity, from the first shelf to at least a second shelf horizontally disposed in elevation between the tank and the first shelf;
d) passing the liquid through the second shelf; and
e) depositing the liquid back into the tank.
